(19) United States
(12) Patent Application Publication
(10) Pub. No.: US 2006/0124012 A1
(43) Pub. Date: Jun. 15, 2006

(54) Method and device for the real time control of print images

(76) Inventor: Bernhard Frei, Konstanz (DE)

Correspondence Address: SCHIFF HARDIN, LLP;PATENT DEPARTMENT, 6600 SEARS TOWER, CHICAGO, IL, 60606-6473, US

(21) Appl. No.: 10/537,479

(22) PCT Filed: Dec. 19, 2003
(86) PCT No.: PCT/EP03/14630

§ 371 Date: Oct. 20, 2005

(30) Foreign Application Priority Data
Dec. 20, 2002 (DE) 10261221.8

(51) Int. Cl. B41F 33/00

(52) U.S. Cl. 101/484

(57) ABSTRACT

In a method for monitoring of a print image, a real image is electro-optically detected and digitized in individual pixels. A reference image is provided that is segmented into a plurality of segments such that respective pixels in the respective segments exhibit approximately a same color property as the respective segments, a reference value describing said color property being associated with the pixels arranged in the respective segments. Color properties of the pixels of the real image are compared with the corresponding reference values of the reference image, and given a deviation from a predetermined threshold value, a corresponding pixel is marked as an error in a result image.

### BACKGROUND

The preferred embodiment concerns a method and a device for real-time monitoring of print images.

In the production of print jobs, print errors can only be detected via purely visual observation at a later point in time due to the high speed with which print jobs are moved in printing systems. The visual monitoring of print images is in particular difficult with continuous printing, since it is not possible to single out and to check an advance copy. If misprints are detected too late or not at all, high costs arise.

However, incorrectly operating monitoring devices that trigger an error alarm can also incur unwanted costs due to the shutdown of the printing path.

Therefore there exists a significant need for a robust method that reliably, safely and quickly detects print errors in the operation of a printing path.

Video cameras with stroboscopic illumination are used for what is known as online print monitoring. The images supplied by these cameras can then be visually monitored and supplied to an automatic monitoring unit.

A known method for automatic monitoring of print works is described in DE 199 40 879 A1. In this method, a reference image is generated or provided if it already exists in digital form. A REAL image is detected by means of a stroboscopic light flash. The position of the REAL image is mapped on the reference image by means of a suitable correlation method. Since an exact superimposition of the reference image and the REAL image is not possible in practice, the reference image is sub-divided into sub-regions. The individual sub-regions can connect to one another without gaps or even an overlap. The differences of the color values of the pixels are determined in each sub-region. If the difference in a sub-region is greater than a predetermined tolerance threshold, the label “structure” is associated with the sub-region, and the label “color” is associated with the sub-region in the case that all differences in the sub-region are smaller than a predetermined tolerance threshold. The REAL image is compared with the desired color values in sub-regions with which the label “color” is associated based on the REAL color values. In sub-regions with which the label “structure” is associated, the average values or the sum of the amplitudes of all grey levels are determined and compared.

This method has proved itself well in practice. However, there are fundamental disadvantages. Individual pixels of the REAL image are compared with the parameters of a sub-region that, given the label structure, do not precisely describe the color property. The quality of this monitoring method depends very much on whether the morphology of the printed image randomly coincides with the arrangement of the sub-regions. Since the individual regions are predetermined in fixed, in particular long, narrow or short and wide sections of an image which possess a specific color property, they are not precisely monitored since they extend over a plurality of sub-regions, and in each sub-region the monitoring parameters to be determined have only a fractional influence.

A method for comparison of print images is known from the document DE-A-199 40 879, in which currently-acquired images are compared with a reference image. The images to be compared are stored in pixel data. A system for monitoring of colors of print images is known from the document U.S. Pat. No. 6,024,018, in which the image to be monitored is separated into regions that are then evaluated.

### SUMMARY

It is an object to achieve a method and a device for monitoring of print images with which the reliability and quality of the monitoring is significantly increased relative to conventional methods or devices.

In a method for monitoring of a print image, a real image is electro-optically detected and digitized in individual pixels. A reference image is provided that is segmented into a plurality of segments such that respective pixels in the respective segments exhibit approximately a same color property as the respective segments, a reference value describing said color property being associated with the pixels arranged in the respective segments. Color properties of the pixels of the real image are compared with the corresponding reference values of the reference image, and given a deviation from a predetermined threshold value, a corresponding pixel is marked as an error in a result image.

### BRIEF DESCRIPTION OF THE DRAWINGS

FIG. 1 shows schematically, in a flow diagram, a method for real-time monitoring of print images;

FIG. 2 illustrates schematically, in a flow diagram, a method for segmenting a reference image;

FIG. 3 shows a method for segmenting a reference image using some few pixels;

FIG. 4 illustrates a printing system in which the method of the preferred embodiment is used;

FIG. 5 illustrates a reference image;

FIG. 6 shows the segments of the reference image from FIG. 5;

FIG. 7 illustrates a REAL image;

FIG. 8 illustrates a result image;

FIG. 9 shows a further reference image;

FIG. 10 illustrates the image from FIG. 9 after the segmentation;

FIG. 11 shows the image from FIG. 10 after the connection of individual segments; and

FIG. 12 illustrates the edges of the segments of the images from FIGS. 9 through 11.

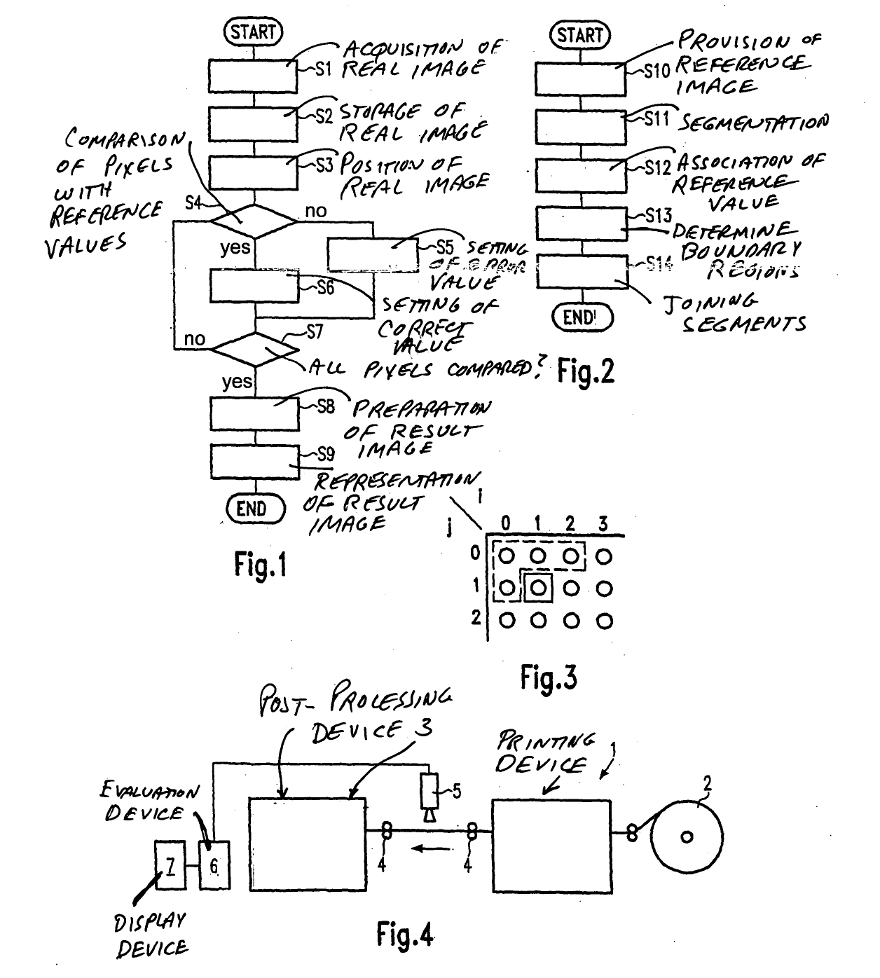

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

The method of the preferred embodiment for monitoring of print images comprises the following steps:
electro-optical detection and digitization of a REAL image in individual pixels,
use of a reference image that is segmented into a plurality of segments such that the segments respectively exhibit a specific color property, whereby a reference value describing the color property is associated with the pixels arranged in the respective segment,
comparison of the color property of the pixels of the REAL image with the corresponding reference values of the reference image, whereby a corresponding pixel is marked as an error in a result image given a deviation above a predetermined threshold value, and whereby boundary regions of the segments are not considered in the comparison.

In the preferred embodiment, a reference image is used that is segmented into a plurality of segments such that the segments respectively exhibit a specific color property. Thus no randomly previously established sub-regions are used, but rather segments that in the reference image respectively comprise a region with an essentially identical color property. The segments thus reproduce the morphology of the image. Given this special design of the segments, significantly more precise reference values can be used than is the case in conventional methods in which the sub-regions have been randomly established.

In the method of the preferred embodiment, the pixels of the REAL image are thus compared with a very precise reference value, whereby deviations can be very reliably detected.

Color properties in the sense of the following preferred embodiment can, for example, be grey values and/or color values.

In particular a real-time monitoring of print images is possible with the preferred embodiment.

According to a preferred method, boundary regions of the segments are not considered upon comparison of the pixels of the REAL image with the corresponding reference values of the reference image, whereby small register shifts (that are often unpreventable and are not viewed as errors by an observer) do not lead to unwanted error data.

A result image in which the error data can be binarily associated with the individual pixels of the result image is generated with the image of the preferred embodiment. The result image can thus be shown as a binary image in which the regions are marked in which errors occur. Such a binary image can simply be shown on a display device and indicates the error locations of a printed image to an operator. The operator can thus quickly and simply detect the errors and, in the event that it is necessary, take corresponding correction measures.

Such a binary result image can also be very significantly compressed with known compression methods since it comprises only large-area binary (black/white) regions. This allows that the result images can be transferred to a monitoring station in real time over a data line with limited transfer capacity. The compressed result images can be uncompressed again at the monitoring station and shown on a display device.

The preferred embodiment also provides a method for segmentation of a reference image in which regions with the same color property are determined, whereby these regions respectively form a segment. A reference value describes the color property of the respective segment tomography imaging system respectively associated with these segments.

The method of the preferred embodiment for real-time monitoring of print images is used in a printing system (FIG. 4). Such a printing system comprises a printing device 1. The method of the preferred embodiment is typically used in high-capacity printers and in particular printers printing on continuous paper. Such a continuous paper is drawn from a paper roll 2 and is supplied to the printing device 1. A post-processing device 3 in which, for example, the continuous paper is cut into individual sheets is typically downstream from the printing device 1. The paper is conducted from the printing device 1 to the post-processing device 3 along a paper track (schematically represented in FIG. 3 by two roller pairs 4).

A line camera 5 that is directed (with its objective) towards the printed paper web is arranged on the paper track. The passing paper can be electro-optically detected with such a line camera and these digital images can be individually created on the paper web for printed pages. These digital images respectively represent a REAL image.

Instead of a line camera, a different electro-optical detection device can also be used such as, for example, a camera for acquisition of a two-dimensional image in combination with a stroboscope, whereby the paper web is illuminated with light flashes emitted by the stroboscope such that individual pages of the moving paper web are respectively recorded.

The camera 5 is connected with an evaluation device 6 that is typically a computer with a storage device and a central calculation device. The evaluation device 6 is connected with a display device 7.

The REAL image generated by the camera 5 is stored in an image storage in the evaluation device 6 (step S2).

The position of the stored REAL image is determined relative to a desired position. This can occur using register markings or specific identifiers in the image itself. Diverse correlation methods for this are known in the prior art. An affine transformation with which the individual pixels of the REAL image can be mapped to the desired position is determined using this position determination (step S3).

Afterwards the individual pixels of the desired image or their color properties are compared with the reference values of a reference image (step S4) in a loop. In this comparison, the pixel that should be compared with the reference image is initially mapped to the corresponding location in the reference image by means of the affine transformations. The reference image is divided into segments. This division is explained in detail below. A reference image is associated with each segment. In this comparison, it is established in which segment the affine-transformed pixel lies, whereby the reference value associated with the segment is then used for the comparison. If the color property of the pixel of the REAL image deviates from the correspondingly-selected reference value by a predetermined threshold value (result of the comparison: no), this means that the pixel does not possess the desired color property. In such a case, in a result image a pixel at the corresponding position in the image is associated with a value that represents the error (step S5). If the color property of the pixel of the REAL image is within the range around the reference value that is predetermined by the threshold value (result of the comparison: yes), this means that this pixel possesses the desired color property, and the corresponding pixel in the result image is associated with a value that designates the correctness of this pixel. For example, in the result image the error values are set with a “1” and the correct values are set with a “0”.

Afterwards it is checked whether all pixels of the desired image have been compared with corresponding reference values (step S7).

The result image is prepared in step S8. Individual pixels or a few pixels that are contiguous and marked as wrong are set back to the correct value. A single pixel or a few contiguous pixels (whereby their number depends on the resolution of the image) are not detected by an observer of a printed image and are therefore not considered in the present method.

The result image is shown on the display device 7 (step S9) so that the result image can be observed by the operator of the printing system.

As an option it can be provided to compress the result image after its preparation in order, for example, to transfer it over a local network to a monitoring station at which the result image is decompressed and shown on a display device. It has been shown that the binary result image, which is typically comprised of large-area regions with error values or correction values, can be very significantly compressed and therefore can be quickly and simply transferred as a small amount of data, even over data lines of lower data capacity.

The color properties can be represented by grey values and/or by color values in the method described above. If color values are used, a color property can thus be described by a plurality of values. If, for example, the color property is represented in RGB space, a color value for red, green and blue are to be specified for each color property. Given such multi-dimensional color properties, an interval value is used as a threshold value. This can, for example, be a specific Euclidian interval in the color space. However, it can also be appropriate to correspondingly vary the interval according to human perception, which is developed significantly differently with different colors. For example, for this the RGB data of the REAL image are transferred into a color space which takes into account the properties of human color interval perception (for example CIELa*b*)

The desired values are then likewise provided in such a color space so that the Euclidian interval can also be used here.

However, there are also color interval measures that cannot be calculated in a Euclidian manner. Here a more complex calculation is then necessary. The determination of these interval measures is established in standard lettering. However, the bases are nevertheless specially-selected color spaces.

In the preferred embodiment, the boundary regions of the segments are not considered in the comparison of the pixels of the REAL image with the corresponding reference values in step S4. This is appropriate since, in spite of the affine transformations, remaining congruence errors can arise. These can arise due to uncertainties of the spatial determination or non-linear variations of the REAL and desired images against one another, for example via hygroeexpansivity or sagging. This means that individual pixels in the boundary region could be incorrectly associated with an adjacent segment, whereby a false evaluation of the pixel would result. These problems in the boundary region are thus remedied by the non-consideration of the boundary region. The width of the boundary region depends on the resolution of the reference image. Suitable widths of the boundary region lie in the range from 1 to 10 pixels, preferably in the range of 1 to 4 pixels.

The association of the reference values is achieved in a program-technical manner in that a label is associated with each segment and the color property is associated with each label. If the color property is a grey level, this association can, for example, be represented according to the following table:

| Label | Grey level |
|---|---|
| 0 | Nop |
| 1 | 100 |
| 2 | 130 |
| 3 | 215 |
| 4 | 190 |
| 5 | 160 |
| 6 | 235 |
| 7 | 80 |
| 8 | 55 |
| 9 | 30 |
| 10 | 255 |

The label 0 is associated with the boundary regions and a code “nop” (which means “no operation”) is associated with the label 0 instead of a grey level. If a pixel lies in the boundary region, upon comparison the code for “no operation” is hereby invoked, whereby the comparison is not executed. The corresponding grey levels are respectively invoked for the further labels 1-10. In the comparison itself, the absolute value is established between the grey level of the reference value and the grey level of the pixel to be compared, and it is checked whether this absolute value is smaller than the threshold value. If this is the case, the grey value of the pixel thus lies in the desired range and the correct value is set in the result image. Otherwise the error value is set in the result image.

If color values are used instead of the grey values, a set of color values that describe the respective color are respectively associated with each label.

A method for segmenting a reference image is subsequently explained (FIG. 2). A reference image must initially be provided (step S10). The provision or generation of a reference image can occur in that an error-free printout of the image is recorded with the optical detection device 5 (which is also used to record the REAL image) in order to generate a digital image file from the image.

On the other hand, in the event that the image to be printed already exists as a digital image file, it is also possible to use this image file directly. However, it is appropriate to adapt the resolution (i.e. the number of the pixels per lengthwise unit in each row and column) of this image file to the resolution of the REAL image. As a rule, the resolution of the REAL image might be somewhat less than that of the image file serving as a master copy, which is why the resolution is reduced in a corresponding manner by means of suitable and known interpolation methods.

Afterwards, contiguous regions in the reference image are determined that possess approximately the same color properties, whereby one such region respectively forms a segment (step S11). This can, for example, be executed according to the following:
The pixels are individually, respectively associated with a segment, whereby the pixels in each row j (FIG. 3) are processed from left to right, and the individual rows in succession from top to bottom.
The reference values of the three adjacent pixels in the row above this pixel and the reference value of the adjacent pixel to the left of the pixel to be associated are read out from a pixel to be associated with a segment. If the pixels are arranged in rows j and columns i, relative to the to-be-associated pixel with the coordinates (i, j), the reference values of the pixels with the coordinates (i−, j−1), (i, j−1), (i+1, j−1) and (i−1, j) are read out.
It is subsequently determined which of the four reference values is most similar to the color property of the pixel to be associated.
If the difference of this reference value and the color property of the pixel to be associated is less than a predetermined threshold, the pixel to be associated is associated with the segment that contains the pixel whose reference value is nearest to the color property of the pixel to be associated.
This association occurs in that the pixel to be associated with the label of this segment is plotted in the reference image.

If the color property of the pixel to be associated differs from the closest reference value by more than the threshold, this pixel can be associated with none of the adjacent segments. This pixel forms the core for a new segment, whereby a new label of the association table is generated and this new label is registered in the reference image at the location of the pixel.

The color property of the one pixel that has initiated the formation of the new segment is initially associated with the new label in the association table. This color property can be associated with this label as a reference value (step S12). Alternatively it is possible to use the average value of the color properties of the individual pixels of a segment as a reference value. Upon addition of a new pixel to a segment, its color property is averaged with the previously determined reference value of the segment with the corresponding weighting.

If the reference image is completely segmented, the reference image is comprised of contiguous regions whose pixels are respectively associated with a specific label. The label for the boundary region, namely the label “0”, is now associated with the pixels of the boundary regions of the segments (step S13).

According to the preferred embodiment, it is examined whether segments exist that comprise less than a predetermined number of pixels and therewith are smaller than a predetermined size. If such segments are present, it is checked whether the color properties of adjacent segments do not differ from the color property of this small segment by a predetermined second threshold. If this is the case, both of these segments are joined into a single segment, whereby a new label is associated with this new segment. The weighted average value from the reference values of both original labels is associated with this new label as a reference value. With the joining of small segments with further segments, the division into very small segments is prevented insofar as it is possible since such small segments are not advisable for the monitoring of the print image, in particular when a boundary region is provided that is not checked.

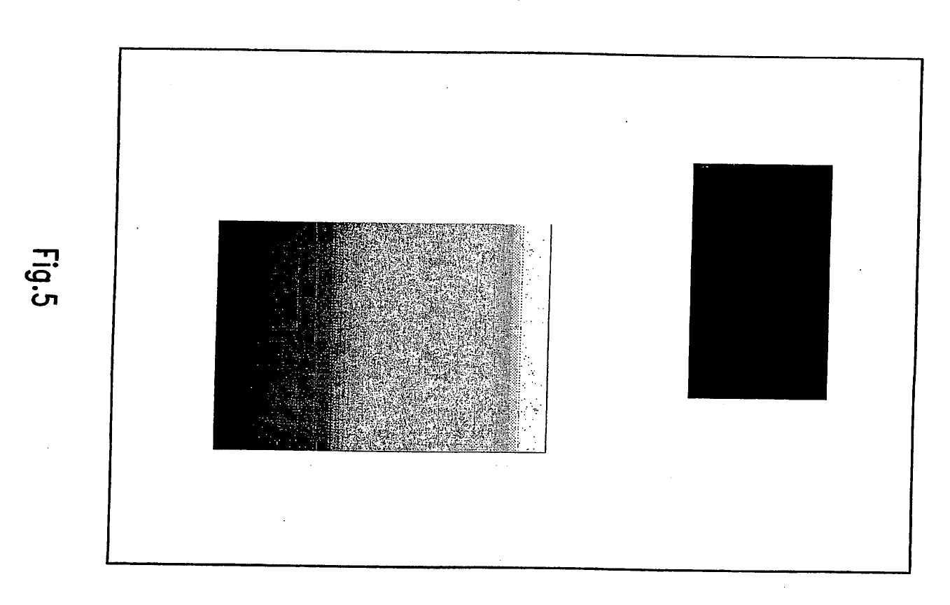

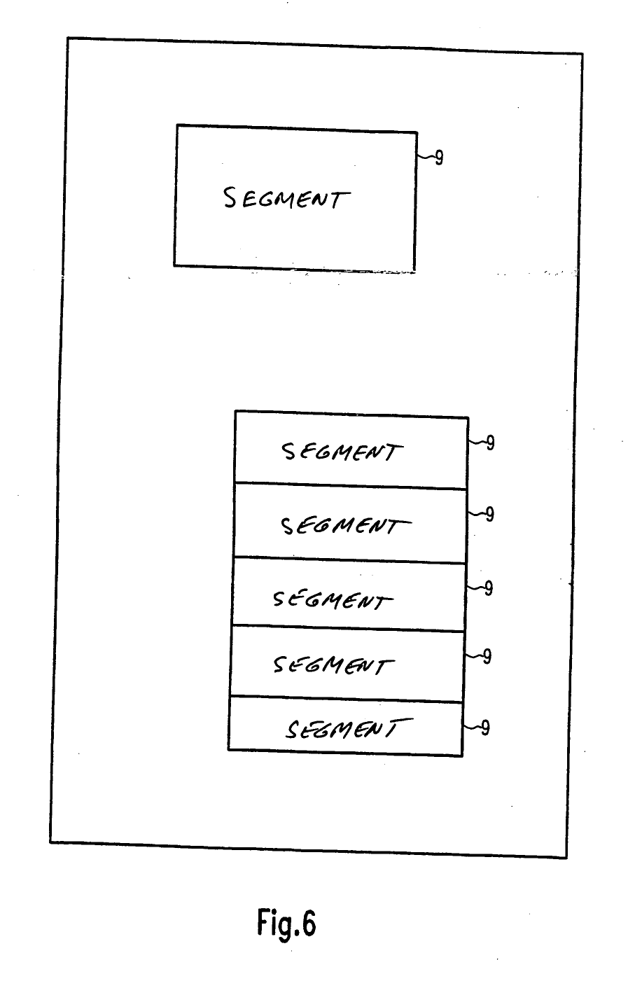

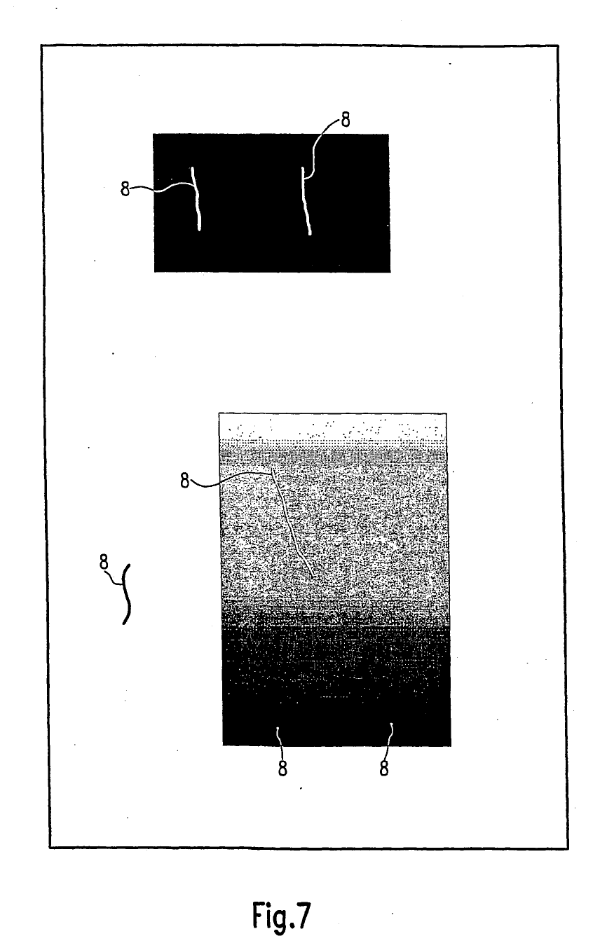

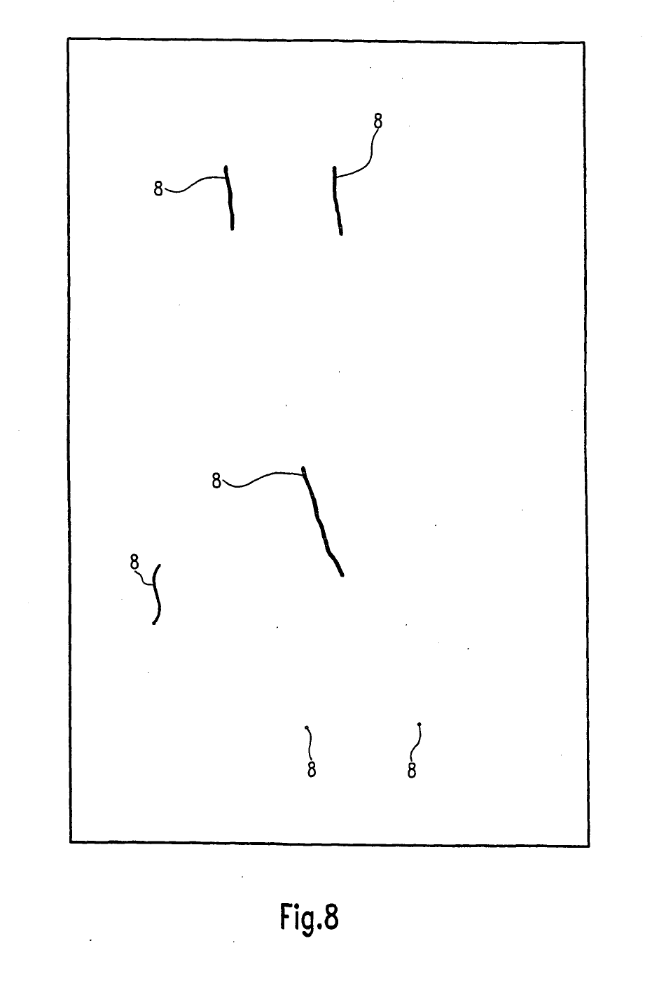

FIG. 5 shows a reference image that comprises two rectangles. The upper rectangle is completely black and the lower rectangle exhibits a color gradient of black/white in the direction from bottom to top. FIG. 6 shows the boundaries of the segments of the reference image shown in FIG. 5. The black rectangle forms a single segment 9. The lower rectangle with the linear color gradient is divided into a plurality of stripe-shaped segments 9 whose reference value describes the average color property of the respective stripe, i.e. the average brightness or the grey values of this stripe. FIG. 8 shows a REAL image in which certain regions 8 are not correctly printed. In the result image (FIG. 8) that has been determined according to the method explained above these incorrectly-printed regions 8 are shown in black and the remaining area of the result image is white. An operator of the printing system who sees the black regions of the result image immediately recognizes that a misprint exists and can initiate suitable measures to correct the misprint.

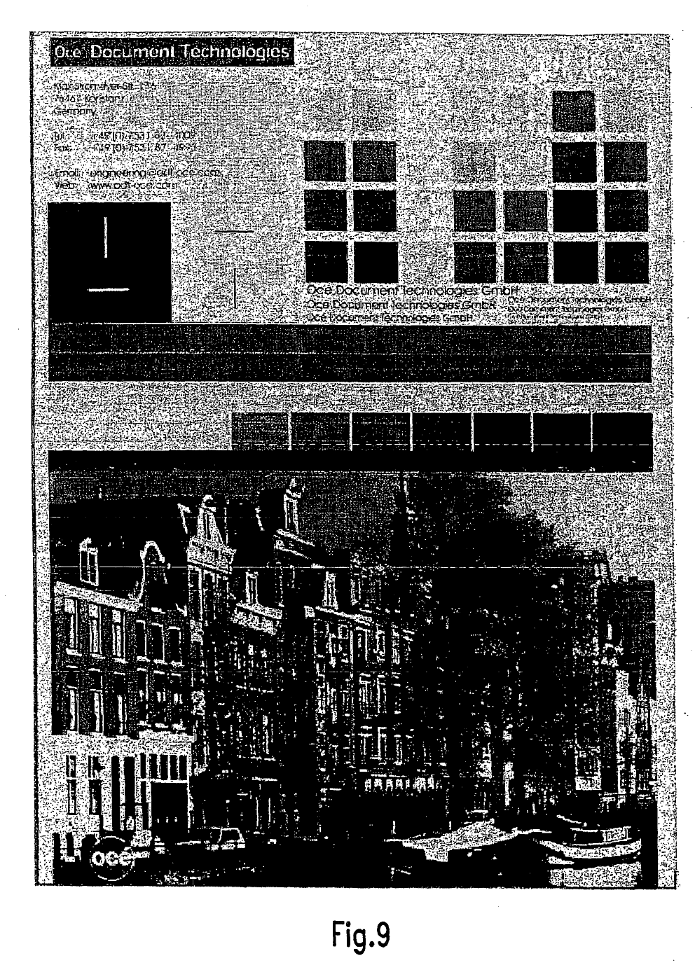

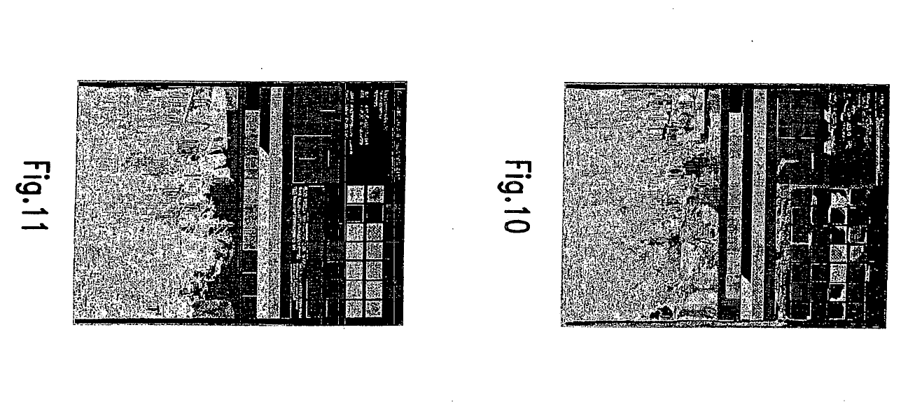

FIG. 9 shows a further reference image. FIG. 10 shows the reference image from FIG. 9 after the segmenting according to step S11. A specific color property is associated with each segment. The individual segments are here respectively represented by the color property that, in the present case, is a grey level. However, the representation of the color properties here occurs with false colors, meaning that the brightness of the individual segments in FIG. 10 allows no conclusions about the actual grey level of the respective segment. Many small “specks” that respectively form a segment are recognizable in FIG. 10.

FIG. 11 shows the image segmented according to FIG. 10 after the joining of segments according to step S14. Here it is clearly recognizable that many regions with small differing specks have been connected into large-area, uniform regions.

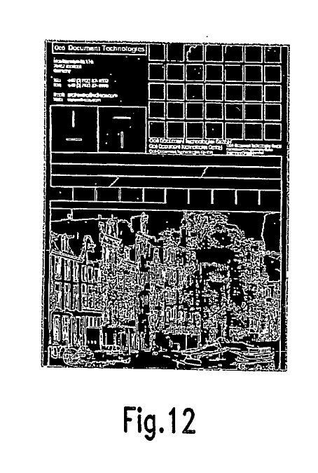

The image according to FIG. 11 was processed further in that, according to step S13, the label 0 has been associated with the boundary regions that have been detected. The boundary regions are shown white in FIG. 12. The remaining regions are shown black. Using FIG. 12, one can easily recognize that the segmentation corresponds to the original morphology (FIG. 9) of the image. As is explained above, a significantly better quality and reliability is thus achieved in the automatic monitoring of printer jobs.

The method of the preferred embodiment is executed on the printing system shown in FIG. 4. The method can be realized as a computer program that is stored on the computer of the evaluation device such that it can be executed. This computer program can be stored on a data medium and can be executed on other printing systems.

The preferred embodiment can be summarized in brief according to the following.

The quality in the automatic monitoring of print images in real time is improved in that a reference image is used that is segmented such that the pixels of the segments possess approximately the same color property. The segments of the reference image hereby approximately reproduce the morphology of the reference image, whereby a reference value that describes the color property of the segment is very well associated with each segment. The pixels of the REAL image are respectively compared with the reference value of the corresponding segment. This comparison is very reliable due to the high quality of the reference value.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

I claim as my invention:

1-13. (canceled)

14. A method for monitoring of a print image, comprising the steps of:
electro-optically detecting and digitizing a real image in individual pixels;
providing a reference image that is segmented to a plurality of segments such that respective pixels in the respective segments exhibit approximately a same color property as the respective segments, a reference value describing said color property being associated with the pixels arranged in the respective segments; and
comparing color properties of the pixels of the real image with the corresponding reference values of the reference image, and given a deviation above a predetermined threshold value, marking a corresponding pixel as an error in a result image, boundary regions of the segments not being considered in the comparison.

15. A method according to claim 14 wherein the color properties associated with the segments are grey levels or color values, or grey values and color values.

16. A method according to claim 14 wherein the pixels of the real image are mapped to corresponding pixels of the reference image via an affine mapping before the comparison.

17. A method according to claim 14 wherein the boundary regions exhibit a width of 1 to 10 pixels.

18. A method according to claim 14 wherein the result image is prepared in that individual pixels or a few pixels that are contiguous and marked as errors are reset in the result image, such that these pixels are not marked as errors in the prepared result image.

19. A method according to claim 14 wherein the result image is compressed for transfer to a monitoring station.

20. A method according to claim 14 wherein for the segmentation of the reference image
providing a digital reference image with a plurality of pixels;
determining contiguous regions with approximately the same color property, such a region respectively forming the segment; and
associating the reference value with the pixels of the segment, the reference value being a measurement for the color property of the respective segment.

21. A method according to claim 20 wherein a non-reference value is associated with the pixels at the boundary region of the segments, which means that said pixels are not to be compared with the pixels of the real image.

22. A method according to claim 20 wherein in the determination of contiguous regions with the same color property, all pixels are selected for such a region whose color property values lie within a certain range around the value of said color property.

23. A method according to claim 20 wherein segments that are smaller than a predetermined size and that exhibit an adjacent segment whose color property is less removed than a predetermined color interval from the color property of said segment is joined with the adjacent segment, a color property averaged from the color properties of both segments being used as a color property of the joined segment.

24. A method according to claim 14 wherein the monitoring of the print image is a real-time monitoring.

25. A device for real-time monitoring of a print image, comprising:
a printing device;
an optical scanning device which scans the printed material;
an evaluation device that is connected with the optical scanning device, the evaluation device comprising a computer with a storage and a central processor;
a program stored in the storage of the evaluation device; and
the program monitoring the print image by
digitizing a real image in individual pixels,
segmenting a reference image into a plurality of segments such that respective pixels in the respective segments exhibit approximately a same color property as the respective segments, a reference value describing said color property being associated with the pixels arranged in the respective segments, and
comparing color properties of the pixels of the real image with the corresponding reference values of the reference image, and given a deviation above the predetermined threshold value, marking a corresponding pixel as an error in a result image, boundary regions of the segments not being considered in the comparison.

26. A software product for monitoring of a print image wherein a reference image is provided for said monitoring, and wherein a real image is detected and digitized in individual pixels, said software product executing a method comprising the steps of:
segmenting the reference image into a plurality of segments such that respective pixels in the respective segments exhibit approximately a same color property as the respective segments, a reference value describing said color property being associated with the pixels arranged in the respective segments; and
comparing color properties of the pixels of the real image with the corresponding reference values of the reference image, and given a deviation above a predetermined threshold value, marking a corresponding pixel as an error in a result image, boundary regions of the segments not being considered in the comparison.

27. A software product according to claim 26 wherein it is stored on a machine-readable data medium.

28. A method for real-time monitoring of a print image, comprising the steps of:
detecting and digitizing a real image in pixels;
providing a reference image and segmenting that reference image into a plurality of segments such that respective pixels in the respective segments exhibit approximately a same color property as the respective segments, a reference value describing said color property being associated with the pixels arranged in their respective segments; and
comparing color properties of the pixels of the real image with the corresponding reference values of the reference image, and given a deviation from a predetermined threshold value, marking a corresponding pixel as an error in a result image.
